(19) United States
(12) Patent Application Publication
(10) Pub. No.: US 2025/0173570 A1
(43) Pub. Date: May 29, 2025

(54) System and Method of Scheduling a fusion route for a Machining Learning Architecture

(71) Applicant: MEDIATEK INC., Hsin-Chu (TW)

(72) Inventors: Yu-Chen Lin, Hsinchu City (TW); Po-Hua Huang, Hsinchu City (TW); Hong-Ruei Jhang, Hsinchu City (TW); Meng-Hsuan Yang, Hsinchu City (TW)

(73) Assignee: MEDIATEK INC., Hsin-Chu (TW)

(21) Appl. No.: 18/519,082

(22) Filed: Nov. 27, 2023

(51) Int. Cl. G06N 3/082

(52) U.S. Cl. CPC G06N 3/082

(57) ABSTRACT

A method of scheduling a fusion route for a machining learning architecture includes adding at least one new fusion to at least one maintained fusion route, wherein each maintained fusion route comprises at least one fusion, and each fusion comprises at least one OP of the plurality of operation units (OPs), calculating a total execution cost of the at least one maintained fusion route after the at least one new fusion is added, comparing all total execution costs of all maintained fusion routes having a same end OP, and selecting a maintained fusion route having a lowest total execution cost from all maintained fusion routes having the same end OP, and discarding all other maintained fusion routes having the same end OP.

### BACKGROUND

The idea of artificial neural networks has existed for a long time. Nevertheless, limited computation ability of hardware has been an obstacle to related research. Over the last decade, there have been significant progresses in computation capabilities of processors and algorithms of machine learning. Not until recently did an artificial neural network that can generate reliable judgments become possible. Gradually, artificial neural networks are experimented in many fields such as autonomous vehicles, image recognitions, natural language understanding applications, and data mining applications.

To improve operational efficiency of executing a deep learning model of the artificial neural networks, an accelerator can be introduced to assist in executing a deep learning mechanism. However, although the accelerator can be used for improving operational efficiency of executing the deep learning model, when a software program of the accelerator is not optimized, hardware of the accelerator cannot be efficiently driven.

Therefore, to optimize the software program of the accelerator for greatly improving the operational efficiency of executing the deep neural networks is an important design issue.

### SUMMARY

In an embodiment of the present invention, a method of scheduling a fusion route for a machining learning architecture is disclosed. The machining learning architecture comprises a plurality of operation units (OPs). The method comprises adding at least one new fusion to at least one maintained fusion route, wherein each maintained fusion route comprises at least one fusion, and each fusion comprises at least one OP of the plurality of OPs, calculating a total execution cost of the at least one maintained fusion route after the at least one new fusion is added, comparing all total execution costs of all maintained fusion routes having a same end OP, and selecting a maintained fusion route having a lowest total execution cost from all maintained fusion routes having the same end OP, and discarding all other maintained fusion routes having the same end OP.

In another embodiment of the present invention, a system of scheduling a fusion route for the machining learning architecture is disclosed. The system comprises a processor. The machining learning architecture comprises a plurality of operation units (OPs). The processor adds at least one new fusion to at least one maintained fusion route. Each maintained fusion route comprises at least one fusion. Each fusion comprises at least one OP of the plurality of OPs. The processor further calculates a total execution cost of the at least one maintained fusion route after the at least one new fusion is added. The processor further compares all total execution costs of all maintained fusion routes having a same end OP. The processor further selects a maintained fusion route having a lowest total execution cost from all maintained fusion routes. The processor further discards all other maintained fusion routes having the same end OP.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a system of scheduling a fusion route for a machining learning architecture according to an embodiment of the present invention.

FIG. 2 is an illustration of initially generating at least one maintained fusion route of the system in FIG. 1.

FIG. 3 is an illustration of adding at least one new fusion to at least one maintained fusion route of a graph schedule structure of the system in FIG. 1.

FIG. 4 is an illustration of how to select a maintained fusion route having a lowest total execution cost from all the maintained fusion routes having a same end OP of the system in FIG. 1.

FIG. 5 is a flow chart of performing a method of scheduling a fusion route for the machining learning architecture.

### DETAILED DESCRIPTION

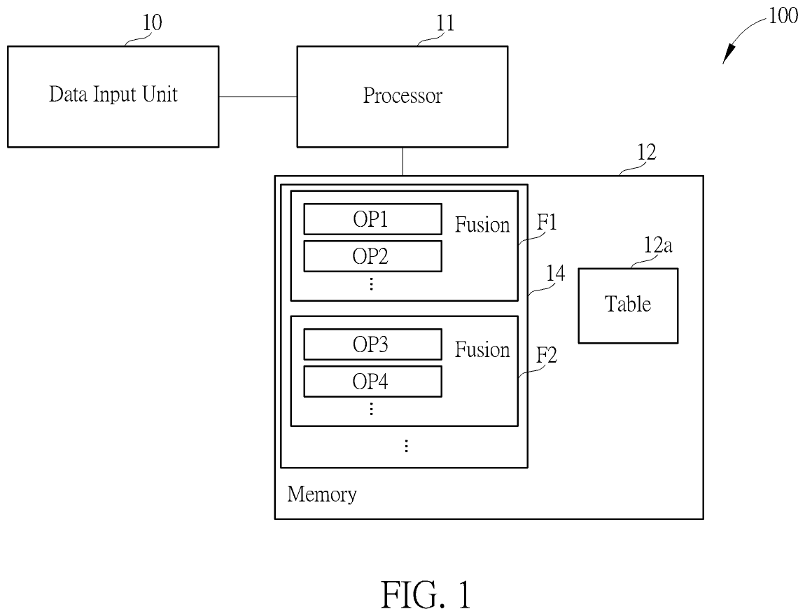

FIG. 1 is a block diagram of a system 100 of scheduling a fusion route for a machining learning architecture according to an embodiment of the present invention. The system 100 can be used for a machining learning architecture of artificial neural networks. The machining learning architecture can be used for executing a deep learning algorithm. The machining learning architecture includes a plurality of operation units (OPs). The system 100 includes a data input unit 10, a processor 11, and a memory 12. The processor 11 is coupled to the data input unit 10. The memory 12 is coupled to the processor 11. In the system 100, the memory 12 can be used for storing a model of the machining learning architecture. For example, a graph schedule structure 14 of the machining learning architecture of the artificial neural networks can be introduced for optimally driving an accelerator. In FIG. 1, the graph schedule structure 14 includes a plurality of fusions, such as a first fusion F1 and a second fusion F2. Each fusion includes at least one layer corresponding to at least one OP. For example, the first fusion F1 can include a first OP OP1 and a second OP OP2. The second fusion F2 can include a third OP OP3 and a fourth OP OP4. A goal of the present invention is to schedule a fusion route for the graph schedule structure 14 to obtain a fusion route having the lowest total execution cost. Since the fusion route can be optimally scheduled, an efficiency of driving the accelerator can be improved.

During scheduling a fusion route for the graph schedule structure 14 of the system 100, the processor 11 can add at least one new fusion to at least one maintained fusion route. Each maintained fusion route includes at least one fusion. Each fusion includes at least one OP of the plurality of OPs. The processor 11 calculates a total execution cost of the at least one maintained fusion route after the at least one new fusion is added. The processor 11 compares all total execution costs of all maintained fusion routes having a same end OP. The processor 11 selects a maintained fusion route having a lowest total execution cost from all maintained fusion routes. Then, the processor 11 discards all other maintained fusion routes having the same end OP. The processor 11 determines if there is only one maintained fusion route and the end OP of the only one maintained fusion is a last OP of the plurality of OPs, the processor 11 configures the only one maintained fusion route as a target fusion route, otherwise the processor 11 repeats previously steps. Therefore, data can be inputted from the data input unit 10 and can be processed by the processor 11 according to the target fusion route having the lowest total execution cost. Details of scheduling a fusion route for the graph schedule structure 14 of the system 100 are illustrated below.

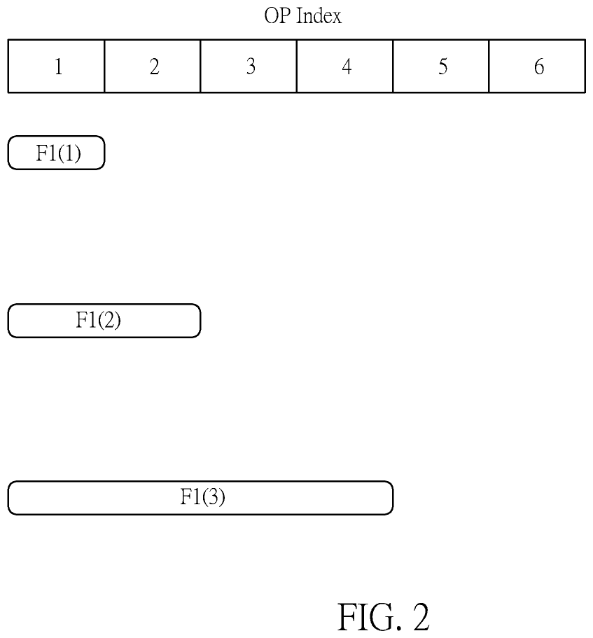

FIG. 2 is an illustration of initially generating at least one maintained fusion route of the system 100. Here, six OPs are introduced to the machining learning architecture. In FIG. 2, the maintained fusion routes can be initially generated by the processor 11, denoted as a maintained fusion route F1(1), a maintained fusion route F1(2), and a maintained fusion route F1(3). The maintained fusion route F1(1) includes only one OP, denoted as OP1. The maintained fusion route F1(2) includes two OPs, denoted as OP1 and OP2. The maintained fusion route F1(3) includes four OPs, denoted as OP1, OP2, OP3, and OP4. In FIG. 2, an end OP of the maintained fusion route F1(1) is OP1. An end OP of the maintained fusion route F1(2) is OP2. An end OP of the maintained fusion route F1(3) is OP4. In other words, at least one maintained fusion route can be generated and starts from the first OP OP1 of the plurality of OPs.

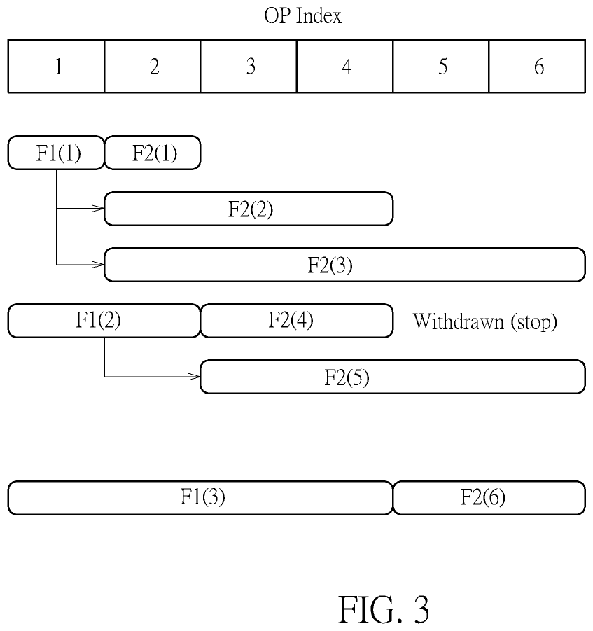

FIG. 3 is an illustration of adding at least one new fusion to at least one maintained fusion route of the graph schedule structure 14 of the system 100. As previously mentioned, each maintained fusion route includes at least one fusion. Each fusion includes at least one OP of the plurality of OPs. Then, the processor 11 can add at least one new fusion to at least one maintained fusion route. For example, a fusion F2(1) can be added to the maintained fusion route F1(1) for updating the maintained fusion route F1(1) as a maintained fusion route {F1(1), F2(1)}, wherein a maintained fusion route {F1(1), F2(1)} represents the maintained fusion route F1(1) combined with the fusion F2(1). A fusion F2(2) can be added to the maintained fusion route F1(1) for updating the maintained fusion route F1(1) as a maintained fusion route {F1(1), F2(2)}, wherein a maintained fusion route {F1(1), F2(2)} represents the maintained fusion route F1(1) combined with the fusion F2(2). A fusion F2(3) can be added to the maintained fusion route F1(1) for updating the maintained fusion route F1(1) as a maintained fusion route {F1(1), F2(3)}, wherein a maintained fusion route {F1(1), F2(3)} represents the maintained fusion route F1(1) combined with the fusion F2(3). A fusion F2(4) can be added to the maintained fusion route F1(2) for updating the maintained fusion route F1(2) as a maintained fusion route {F1(2), F2(4)}, wherein a maintained fusion route {F1(2), F2(4)} represents the maintained fusion route F1(2) combined with the fusion F2(4). A fusion F2(5) can be added to the maintained fusion route F1(2) for updating the maintained fusion route F1(2) as a maintained fusion route {F1(2), F2(5)}, wherein a maintained fusion route {F1(2), F2(5)} represents the maintained fusion route F1(2) combined with the fusion F2(5). A fusion F2(6) can be added to the maintained fusion route F1(3) for updating the maintained fusion route F1(3) a as maintained fusion route {F1(3), F2(6)}, wherein a maintained fusion route {F1(3), F2(6)} represents the maintained fusion route F1(3) combined with the fusion F2(6). In some embodiments, the processor 11 can add a new fusion (such as the fusion F2(6)) at the end of the at least one maintained fusion route (such as the maintained fusion route F1(3)).

Alternatively, the processor 11 can add a first new fusion (such as the fusion F2(4)) at the end of a first maintained fusion route (such as the maintained fusion route F1(2)). The processor 11 can add a second new fusion (such as the fusion F2(5)) at the end of the first maintained fusion route (such as the maintained fusion route F1(2)). Alternatively, the processor 11 can add a first new fusion (such as the fusion F2(1)) at the end of a first maintained fusion route (such as the maintained fusion route F1(1)). The processor 11 can add a second new fusion (such as the fusion F2(2)) at the end of the first maintained fusion route (such as the maintained fusion route F1(1)). The processor 11 can add a third new fusion (such as the fusion F2(3)) at the end of the first maintained fusion route (such as the maintained fusion route F1(1)). Here, each new fusion includes at least one OP of the plurality of OPs. An amount of OPs of each new fusion is determined by a basic structure constraint of the machining learning architecture. For example, basic structure constraint includes a Pad OP that couldn't be an end OP of a fusion.

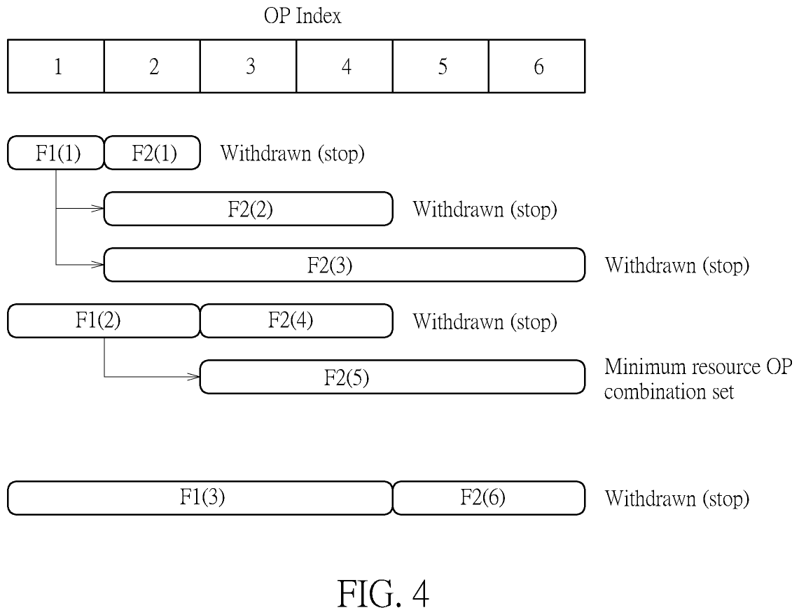

FIG. 4 is an illustration of how to select a maintained fusion route having a lowest total execution cost from all the maintained fusion routes having a same end OP. The processor 11 can calculate a total execution cost of the at least one maintained fusion route after the at least one new fusion is added. Here, the total execution cost can include at least one of external memory access cost, cycles, latency, and MAC operations, and the total execution cost can be calculated according to all fusions of each maintained fusion route. The processor 11 can compare all total execution costs of all maintained fusion routes having a same end OP. For example, in FIG. 4, the maintained fusion route {F1(1), F2(1)} and the maintained fusion route F1(2) have a same end OP OP2, thus the total execution costs of the maintained fusion route {F1(1), F2(1)} is compared with the total execution costs of the maintained fusion route F1(2). Then, the processor 11 can select a maintained fusion route having a lowest total execution cost from the maintained fusion route F1(2) and the maintained fusion route {F1(1), F2(1)}. Since the total execution cost of the maintained fusion route F1(2) is smaller than the total execution cost of the maintained fusion route {F1(1), F2(1)}, the processor 11 selects the maintained fusion route F1(2), and discards the maintained fusion route {F1(1), F2(1)}. Similarly, for the end OP OP4, the total execution costs of the maintained fusion route F1(3) are compared with the total execution costs of the maintained fusion route {F1(1), F2(2)}, and also compared with the total execution costs of the maintained fusion route {F1(2), F2(4)}. Then, the processor 11 can select a maintained fusion route having the lowest total execution cost from the maintained fusion route F1(3), the maintained fusion route {F1(2), F2(4)}, the maintained fusion route {F1(1), F2(2)}. Since the total execution cost of the maintained fusion route F1(3) is smaller than the total execution cost of the maintained fusion route {F1(2), F2(4)} and the maintained fusion route {F1(1), F2(2)}, the processor 11 selects the maintained fusion route F1(3), and discards the maintained fusion route {F1(2), F2(4)} and discards the maintained fusion route {F1(1), F2(2)}. Similarly, for the end OP OP6, the total execution costs of the maintained fusion route {F1(3), F2(6)} are compared with the total execution costs of the maintained fusion route {F1(1), F2(3)}, and also compared with the total execution costs of the maintained fusion route {F1(2), F2(5)}. Then, the processor 11 can select a maintained fusion route having the lowest total execution cost from the maintained fusion {F1(3), F2(6)}, route route the maintained fusion {F1(2), F2(5)}, and the maintained fusion route {F1(1), F2(3)}. Since the total execution cost of the maintained fusion route {F1(2), F2(5)} is smaller than the total execution cost of the maintained fusion route {F1(3), F2(6)} and the maintained fusion route {F1(1), F2(3)}, the processor 11 selects the maintained fusion route {F1(2), F2(5)}, and discards the maintained fusion route {F1(3), F2(6)} and discards the maintained fusion route {F1(1), F2(3)}.

In some embodiments, when the processor 11 selects a maintained fusion route having a lowest total execution cost, the processor 11 determines if there is only one maintained fusion route and the end OP of the only one maintained fusion is the last OP of the plurality of OPs; and the processor 11 configures the only one maintained fusion route as a target fusion route if the end OP of the only one maintained fusion is the last OP; otherwise the processor 11 repeats the steps of adding at least one new fusion to at least one maintained fusion route; calculating a total execution cost of the at least one maintained fusion route after the at least one new fusion is added; comparing all total execution costs of all maintained fusion routes having a same end OP; and selecting a maintained fusion route having a lowest total execution cost from all maintained fusion routes, and discarding all other maintained fusion routes having the same end OP if at least two maintained fusion route is still introduced or the end OP of the only one maintained fusion is not the last OP of the plurality of OPs. For example, in FIG. 4, since the six OPs are introduced to the machining learning architecture, when the processor 11 selects the maintained fusion route F1(2), the processor 11 determines the end OP OP2 isn't the last OP OP6 of the plurality of OPs, the processor 11 adds at least one new fusion ((F2(4) and F2(5)) to at least one maintained fusion route F1(2), calculates a total execution cost of the at least one maintained fusion route ({F1(2), F2(4)} and {F1(2), F2(5)}) after the at least one new fusion is added, compares all total execution costs of all maintained fusion routes ({F1(1), F2(1)}, {F1(2), F2(4)} and {F1(3)) having a same end OP(OP4), selects a maintained fusion route (F1(3)) having a lowest total execution cost from all maintained and fusion routes, discards all other maintained fusion routes {F1(1), F2(1)} and {F1(2), F2(4)} having the same end OP(OP4). Similarly, when the processor 11 selects the maintained fusion route F1(3), the processor 11 determines the end OP OP4 isn't the last OP OP6 of the plurality of OPs, the processor 11 adds at least one new fusion (F2(6)) to at least one maintained fusion route F1(3), calculates a total execution cost of the at least one maintained fusion route ({F1(3), F2(6)}) after the at least one new fusion is added, compares all total execution costs of all maintained fusion routes ({F1(1), F2(3)}, {F1(2), F2(5)} and {{F1(3), F2(6)}) having a same end OP(OP6), selects a maintained fusion route ({F1(2), F2(5)}) having a lowest total execution cost from all maintained fusion routes, and discards all other maintained fusion routes {F1(1), F2(3)} and {F1(3), F2(6)} having the same end OP(OP6). Finally, the maintained fusion route {F1(2), F2(5)} can be selected as a target route having the lowest execution cost of the graph structure 14 of the machining learning architecture. In some embodiments, the processor 11 can save information of the at least one maintained fusion route and/or discarded maintained fusion routes to the table 12a in the memory 12 for updating a list of the maintained fusion routes.

Besides, the amount of OPs of the machining learning architecture in the system 100 is not limited in FIG. 2 to FIG. 4. For example, when the amount of OPs is larger than 6, the processor 11 can continuously repeat the steps mentioned with FIG. 3 and FIG. 4, until the end OP of the only one maintained fusion is the last OP.

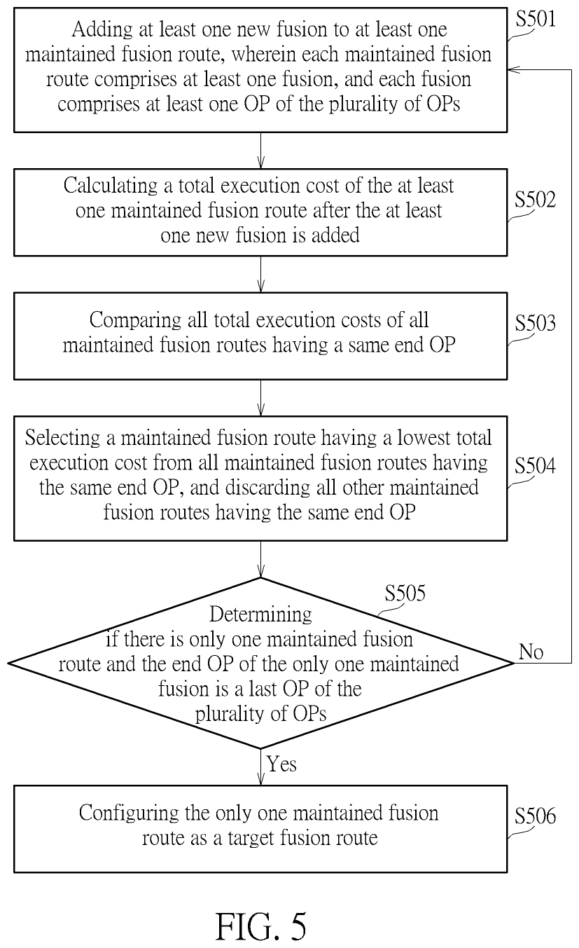

FIG. 5 is a flow chart of performing a method of scheduling a fusion route for the machining learning architecture. The method of scheduling a fusion route for the machining learning architecture includes step S501 to step S506. Any technology modification falls into the scope of the present invention. Step S501 to Step S506 are illustrated below.
Step S501: adding at least one new fusion to at least one maintained fusion route, wherein each maintained fusion route comprises at least one fusion, and each fusion comprises at least one OP of the plurality of OPs;
Step S502: calculating a total execution cost of the at least one maintained fusion route after the at least one new fusion is added;
Step S503: comparing all total execution costs of all maintained fusion routes having a same end OP;
Step S504: selecting a maintained fusion route having a lowest total execution cost from all maintained fusion routes having the same end OP, and discarding all other maintained fusion routes having the same end OP; Step S505: determining if there is only one maintained fusion route and the end OP of the only one maintained fusion is a last OP of the plurality of OPs; if yes, entering step S506; if no, returning to step S501.
Step S506 configuring the only one maintained fusion route as a target fusion route.

Details of step S501 to step S506 are previously illustrated. Thus, they are omitted here. In the system 100, since fusion routes for the machining learning architecture are scheduled, the execution cost of driving all OPs can be minimized. Therefore, the efficiency of performing the accelerator for executing the deep neural networks can be improved.

To sum up, the present invention discloses a method and a system of scheduling a fusion route for a machining learning architecture. Instead of using a greedy search algorithm for introducing numerous cases to execute OPs, the method of the present invention can improve the efficiency of scheduling a fusion route for identifying a target fusion route having the lowest execution cost. Since the fusion route for the machining learning architecture is scheduled, the execution cost of driving all OPs can be minimized. Therefore, the efficiency of performing the accelerator for executing the deep neural networks can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of scheduling a fusion route for a machining learning architecture, wherein the machining learning architecture comprises a plurality of operation units (OPs), the method comprising:
(a1) adding at least one new fusion to at least one maintained fusion route, wherein each maintained fusion route comprises at least one fusion, and each fusion comprises at least one operation unit (OP) of the plurality of OPs;
(a2) calculating a total execution cost of the at least one maintained fusion route after the at least one new fusion is added;
(a3) comparing all total execution costs of all maintained fusion routes having a same end OP; and
(a4) selecting a maintained fusion route having a lowest total execution cost from all maintained fusion routes having the same end OP, and discarding all other maintained fusion routes having the same end OP.

2. The method of claim 1, further comprising:
determining if there is only one maintained fusion route and the end OP of the only one maintained fusion is the last OP of the plurality of OPs, if yes, selecting the only one maintained fusion route as a target fusion route, otherwise repeating the steps of (a1) to (a4).

3. The method of claim 1, further comprising:
generating the at least one maintained fusion route;
wherein the at least one maintained fusion route starts from a first OP of the plurality of OPs.

4. The method of claim 1, wherein adding the at least one new fusion to the at least one maintained fusion route comprises:
adding a new fusion at the end of the at least one maintained fusion route;
wherein the new fusion comprises at least one OP of the plurality of OPs.

5. The method of claim 1, wherein adding the at least one new fusion for the at least one maintained fusion route further comprises:
adding a first new fusion at the end of a first maintained fusion route, wherein the first new fusion comprises at least one OP of the plurality of OPs;
adding a second new fusion at the end of the first maintained fusion route, wherein the second new fusion comprises at least one OP of the plurality of OPs.

6. The method of claim 1, wherein an amount of OPs of a new fusion is determined by a basic structure constraint of the machining learning architecture.

7. The method of claim 1, further comprising:
saving information of the at least one maintained fusion route and/or discarded maintained fusion routes to a table for updating a list of the maintained fusion routes.

8. The method of claim 1, wherein the total execution cost comprises at least one of external memory access cost, cycles, latency, and MAC operations, and the total execution cost is calculated according to all fusions of each maintained fusion route.

9. The method of claim 1, wherein the machining learning architecture comprises a graph structure.

10. The method of claim 1, wherein the machining learning architecture is used for executing a deep learning algorithm.

11. A system of scheduling a fusion route for a machining learning architecture, comprising a processor, wherein the machining learning architecture comprises a plurality of operation units (OPs), and the processor is configured to:
add at least one new fusion to at least one maintained fusion route,
wherein each maintained fusion route comprises at least one fusion, each fusion comprises at least one operation unit (OP) of the plurality of OPs;
calculate total execution cost of the at least one maintained fusion route after the at least one new fusion is added;
compare all total execution costs of all maintained fusion routes having a same end OP;
select a maintained fusion route having a lowest total execution cost from all maintained fusion routes having the same end OP; and
discard all other maintained fusion routes having the same end OP.

12. The system of claim 11, wherein the processor is further configured to determine if there is only one maintained fusion route and the end OP of the only one maintained fusion is the last OP of the plurality of OPs, if yes, the processor configures the only one maintained fusion route as a target fusion route, otherwise the processor repeats previously steps.

13. The system of claim 11, wherein the processor is further configured to generate the at least one maintained fusion route, and the at least one maintained fusion route starts from a first OP of the plurality of OPs.

14. The system of claim 11, wherein the processor is further configured to add a new fusion at the end of the at least one maintained fusion route, and the new fusion comprises at least one OP of the plurality of OPs.

15. The system of claim 11, wherein the processor is further configured to add a first new fusion at the end of a first maintained fusion route, the first new fusion comprises at least one OP of the plurality of OPs, and the processor is further configured to add a second new fusion at the end of the first maintained fusion route, and the second new fusion comprises at least one OP of the plurality of OPS.

16. The system of claim 11, wherein an amount of OPs of a new fusion is determined by a basic structure constraint of the machining learning architecture.

17. The system of claim 11, wherein the system further comprises a memory coupled to the processor, and the processor is further configured to save information of the at least one maintained fusion route and/or discarded maintained fusion routes to a table in the memory for updating a list of the maintained fusion routes.

18. The system of claim 11, wherein the total execution cost comprises at least one of external memory access cost, cycles, latency, and MAC operations, and the total execution cost is calculated according to all fusions of each maintained fusion route.

19. The system of claim 11, wherein the machining learning architecture comprises a graph structure.

20. The system of claim 11, wherein the machining learning architecture is used for executing a deep learning algorithm.
